(19) United States
(12) Patent Application Publication
(10) Pub. No.: US 2020/0214279 A1
(43) Pub. Date: Jul. 9, 2020

(54) INSECT TRAP DEVICE

(71) Applicant: U WELL TECH CORP., Apia (WS)

(72) Inventors: JAU-CHEN TSAI, TAIPEI CITY (TW); HAO-CHUAN FU, NEW TAIPEI CITY (TW); CHAO-CHI TSAI, TAIPEI CITY (TW); KUAN-HAO FU, NEW TAIPEI CITY (TW)

(21) Appl. No.: 16/242,156

(22) Filed: Jan. 8, 2019

(51) Int. Cl. A01M 1/14; A01M 29/18; G06K 9/00; A01M 1/24

(52) U.S. Cl. CPC A01M 1/145; A01M 29/18; A01M 2200/01; A01M 1/24; G06K 9/00771

(57) ABSTRACT

An insect trap device includes a housing, a sticky board, and at least one LED light bar. The housing is formed with a plurality of holes. The sticky board is arranged on a bottom of the housing. The sticky board has a surface coated with insect sticking glue. The at least one LED light bar is arranged in an interior of the housing to form indirect lighting and emit a wavelength of insect luring light. As such, the at least one LED light bar emits light that attracts insects to enter through the plurality of holes of the housing to get stuck to the sticky board.

### FIELD OF THE INVENTION

The present invention relates to an insect trap device, and more particularly to one that involves a combined arrangement of a housing, a sticky board, and at least one LED light bar to allow light emitting from the at least one LED light bar to attract insects to enter through a plurality of holes formed in the housing to get stuck to the sticky board, so as to provide advantages of preventing direct irradiation of lighting onto human bodies to cause damage of human bodies, having improved expandability, insect control and prevention, extended lifespan, deodorization and sterilization, energy saving, environmental friendliness, a compact and light overall structure, being easy to install, and having improved flexibility of use

### BACKGROUND OF THE INVENTION

Conventional insect trapping device often involve direct luring lighting. However, direct lighting may cause undesired damages to human bodies. Further, the conventional insect trapping devices do not include any artificial intelligence systems so that it is generally impossible to conduct, from a remote site, operations for accurately handling and analyzing environmental conditions and carrying out data analysis for providing references for future operations of insect control. In addition, no LED (light emitting diode) lighting has been used in the existing insect trapping devices so that overall power consumption is high. Further, a ultraviolet light source is commonly used in the conventional insect trapping devices and such lighting would irradiate a circuit board inside the trapping devices so that the circuit board is often damaged after being irradiated for a long time. Practically, such known devices do not actually meet the needs of users.

### SUMMARY OF THE INVENTION

In view of the above problems, the primary objective of the present invention is to provide an insect trap device, which comprises a combined arrangement of a housing, a sticky board, and at least one LED light bar such that the at least one LED light bar is arranged in an interior of the housing to form indirect lighting for effectively preventing the lighting from direct irradiation on human bodies to cause damages to eyes, skin, and other organs and to emit a wavelength of insect luring light to attract insects to enter through a plurality of holes formed in the housing to get stuck to the sticky board, thereby achieving an effect of insect trapping and providing practical utilization and safety.

A secondary objective of the present invention is to provide an insect trap device, in which an artificial intelligence monitoring module is provided inside the housing, wherein the artificial intelligence monitoring module is connected to and thus configured with an image capture unit, a detection unit, an infrared light unit, a transmission unit, a display unit, and an ultrasonic rat repellent unit, and wherein the surface of the sticky board has grid lines, together with the functions of date, time, temperature, humidity, image capturing, scanning, transmission, and video/audio playing provided in the artificial intelligence monitoring module to achieve improved overall expandability and effective and accurate handling and analysis of environmental conditions and data analysis at a remote site to provide data of instantaneous insect control operations, wherein the image capture unit that is connected to and configured with the artificial intelligence monitoring module provides monitoring for the number and species of insects that are trapped, and the transmission unit carries out transmission and control of the temperature and humidity of the insert trapping environment in order to reduce the number of specific species of insect, to thereby provide practical utilization and convenience.

A further objective of the present invention is to provide an insect trap device, which comprises a fan arranged in the housing to provide an effect of heat dissipation so as to improve lift span and provide practical utilization.

A further objective of the present invention is to provide an insect trap device, which comprises photo catalyst arranged in the housing (wherein the photo catalyst comprises titanium dioxide), which is irradiated with the at least one LED light bar to provide an effect of deodorization and striation, thereby providing practical utilization and safety.

A further objective of the present invention is to provide an insect trap device, of which the LED light bar is powered by a direct-current power supply and the LED light bar has the advantages of being with a small current and a low voltage so as to provide an effect of power saving, and the power supply unit is one of a direct-current power supply device, an alternate-current power supply device, a battery, a solar cell, or a combination thereof, to supply electrical power, having an effect of energy saving and environmental protection, thereby providing practical utilization.

A further objective of the present invention is to provide an insect trap device, which has a structure the entirety of which is compact and light, having a novel outside appearance, high reliability, and easy maintenance, and such a compact and light overall structure makes it possible for easy installation both indoors and outdoors, or even playing a role of being a decoration to improve flexibility of use thereof, thereby providing practical utilization and convenience.

A further objective of the present invention is to provide an insect trap device, in which a circuit board of the artificial intelligence monitoring module is arranged on the back side of the partition board to prevent damage caused by long term irradiation of the at least one LED light bar, thereby providing practical utilization,

To achieve the above objectives, the present invention provides an insect trap device. The insect trap device comprises a housing, a sticky board; and at least one LED light bar. The housing is formed with a plurality of holes The sticky board is arranged on a bottom of the housing. The sticky board has a surface coated with insect sticking glue. The at least one LED light bar is arranged in an interior of the housing to form indirect lighting and emit a wavelength of insect luring light. As such, the at least one LED light bar emits light that attracts insects to enter through the plurality of holes of the housing to get stuck to the sticky board, so as to provide the effects of trapping insects, preventing direct irradiation of lighting onto human bodies to cause damage of human bodies, having improved expandability, insect control and prevention, extended lifespan, deodorization and sterilization, energy saving, environmental friendliness, having a compact and light overall structure, being easy to install and having improved flexibility of use, so as to enhance practical utilization, convenience, and safety.

### BRIEF DESCRIPTION OF THE DRAWINGS

FIG. 1 is a perspective view illustrating an insect trap device according to the present invention;

FIG. 2 is another perspective view of the insect trap device of the present invention, taken from a different angle;

FIG. 3 is an exploded view showing components of the insect trap device according to the present invention;

FIG. 4 is a cross-sectional view taken along line A-A of FIG. 2;

FIG. 5 is a perspective view showing an insect trap device according to another embodiment of the present invention; and

FIG. 6 is a cross-sectional view taken along line B-B of FIG. 5.

### DETAILED DESCRIPTION OF THE PREFERRED EMBODIMENTS

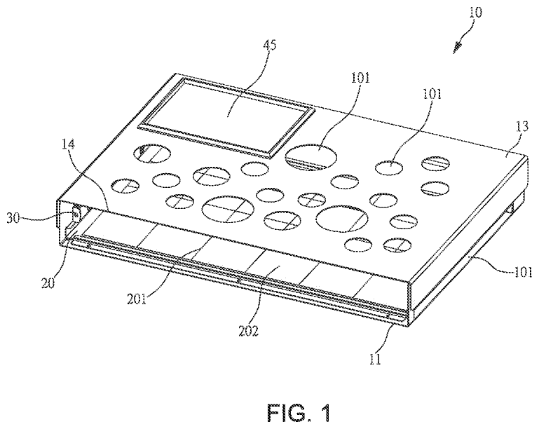

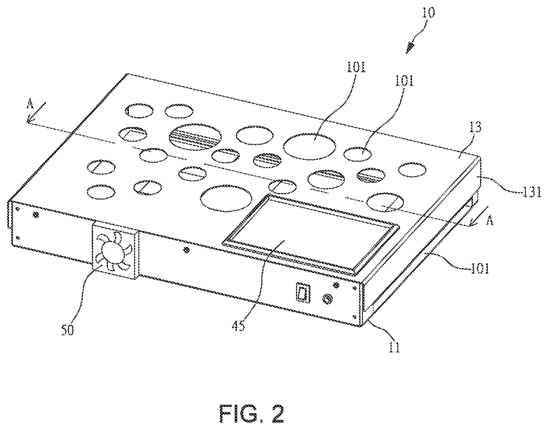

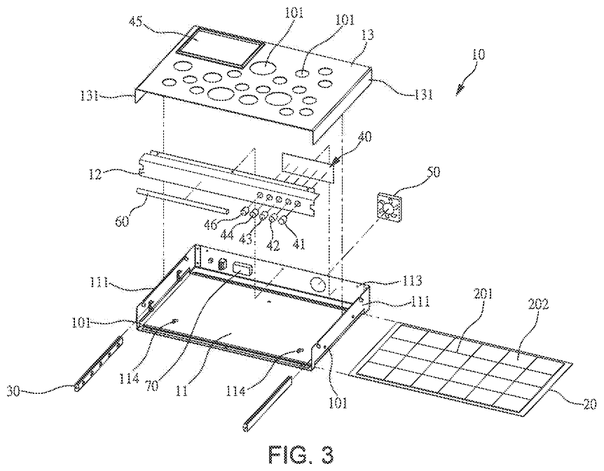

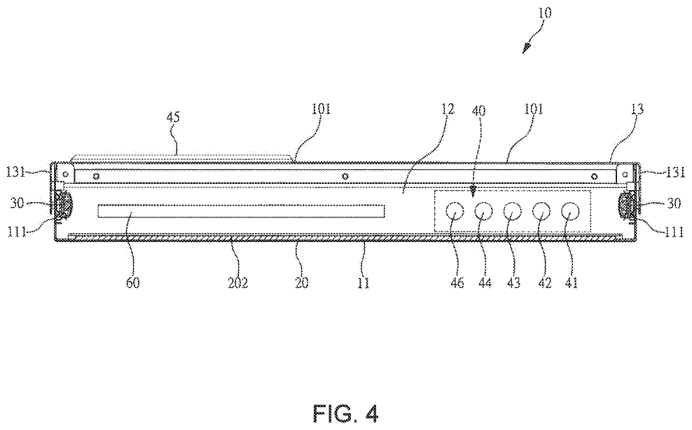

A detailed description will be provided below with reference to preferred embodiments together with the attached drawings. A first embodiment of the present invention is shown in FIGS. 1-4. The present invention provides an insect trap device. The insect trap device comprises: a housing 10, the housing 10 being formed with a plurality of holes 101; a sticky board 20, the sticky board 20 being arranged on a bottom the housing 10, the sticky board 20 having a surface coated with insect sticking glue 202; and at least one light-emitting diode (LED) light bar 30, the at least one LED light bar 30 being arranged in an interior of the housing 10 to form indirect lighting and emit a wavelength to provide insect luring light. As such, the light of the at least one LED light bar 30 attracts insects to enter through the plurality of holes 101 formed in the housing 10 and then get stuck to the sticky board 20.

In addition, the housing 10 is of an integrally formed one-piece structure or is alternatively of a detachable structure, the latter being illustrated in FIGS. 1-4. The housing 10 comprises a bottom base 11, a partition board 12 and a top cover 13. The bottom base 11 is formed with bent side boards 111 respectively on two opposite sides thereof. Each of the bent side boards 111 has a lower portion that is formed with an insertion opening 101 to receive the sticky board 20 to insert into and combine with the bottom base 11 and also to allow insects to enter. Each of the bent side boards 111 is coupled with one LED light bar 30. The bottom base 11 is provided, on a back thereof, with a back board 113. The partition board 12 is disposed on the bottom base 11 that is arranged adjacent to the back board 113. The top cover 13 has two opposite sides respectively formed with folded sections 131, which are respectively combinable with the bent side boards 111 of the two sides of the bottom base 11. The housing 10 is formed, in a front side thereof, with an opening 14. The top cover 13 is formed with the plurality of holes 101 for entry of insects.

Further, the at least one LED light bar 30 provides a light source having a wavelength within the range of ultraviolet light (such as UVA), particularly having a wavelength range of 350-380 nm, with a primary wavelength range of 355-370 nm, for enhancing the performance of insect trapping. Further, the sticky board 20 and the LED light bars 30 may be additionally provided with alarm light or alarm sound.

Further, the housing 10 is additionally provided, in the interior thereof, with an artificial intelligence monitoring module 40, which provides instantaneous monitoring and analysis, wherein the artificial intelligence monitoring module 40 is connected to, and thus provided with, an image capture unit 41, a detection unit 42, an infrared light unit 43, a transmission unit 44, a display unit 45, and an ultrasonic rat repellent unit 46. The surface of the sticky board 20 has grid lines 201 for easy monitoring and analysis. With the artificial intelligence monitoring module 40 being provided with functions of date, time, temperature, humidity, image capturing, scanning, transmission, and video/audio playing, it is possible to effectively and accurately handle and analyze environmental conditions and to carry out data analysis at a remote site to provide data for instantaneous insect control operations, wherein the image capture unit 41 that is connected to and disposed in combination with the artificial intelligence monitoring module 40 provides monitoring for the number and species of insects that are trapped, and the transmission unit 44 carries out transmission and control of the temperature and humidity of the insert trapping environment in order to reduce the number of specific species of insect. The artificial intelligence monitoring module 40 comprises a circuit board that is arranged behind or on the back side of the partition board 12 to prevent damage caused by long term irradiation by the at least one LED light bar 30.

The housing 10 may be additionally provided with a fan 50 for dissipation of heat. The housing 10 is provided therein with photo catalyst 60, and the photo catalyst 60 can be titanium dioxide that is irradiated with the at least one LED light bar 30 to perform deodorization and sterilization.

The housing 10 is provided with a power supply unit 70. The power supply unit 70 can be one of a direct-current power supply device, an alternate-current power supply device, a battery, a solar cell, or a combination thereof to supply electrical power.

The bottom base 11 of the housing 10 is formed with a pair of wall-mounting apertures 114 for mounting to a wall.

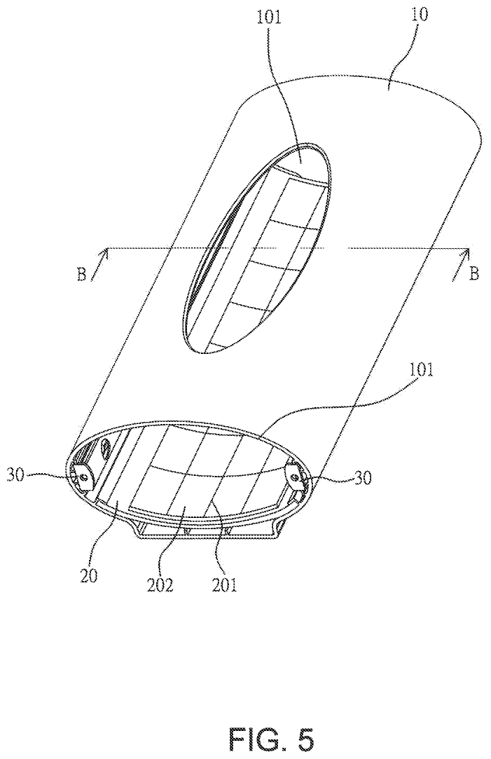

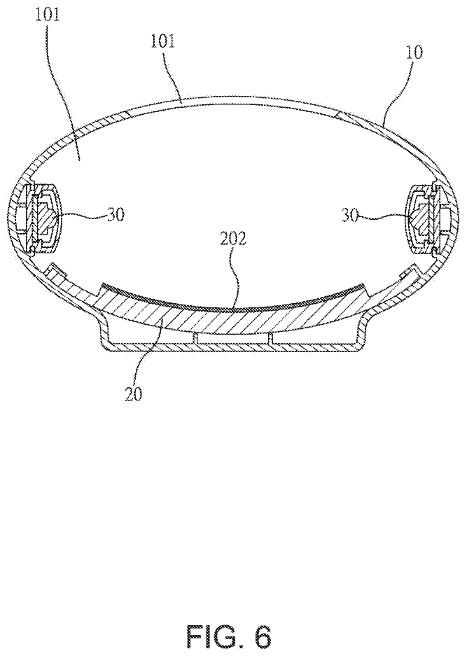

A second embodiment of the present invention is shown in FIGS. 5-6, in which an insect trap device comprises: a housing 10, the housing 10 being formed with a plurality of holes 101; a sticky board 20, the sticky board 20 being arranged on a bottom of the housing 10, the surface of the sticky board 20 having grid lines 201 for easy monitoring and analysis, the sticky board 20 having a surface coated with insect sticking glue 202; and at least one LED light bar 30, the at least one LED light bar 30 being arranged in an interior of the housing 10 to form indirect lighting and emit a wavelength to provide insect luring light. As such, the light of the at least one LED light bar 30 attracts insects to enter through the plurality of holes 101 formed in the housing 10 and then get stuck to the sticky board 20. The second embodiment of the present invention is different from the first embodiment in that in the second embodiment of the present invention, the housing 10 is integrally formed as a one-piece structure in the form of an elliptic hollow pillar that provide the same effects as the first embodiment, of which repeated description will be omitted herein.

The present invention is made by combining components, including a housing 10, a sticky board 20, and at least one LED light bar 30, together such that the at least one LED light bar 30 is arranged inside the housing 10 as an indirect lighting source that effectively helps prevent direct irradiation on human bodies to cause damage to eyes, skins, and other organs of human bodies and that provides a wavelength of insect luring light to attract insects to enter through the plurality of holes 101 of the housing 10 to get stuck to the sticky board 20 to thereby achieving the purposes of insect trapping. The artificial intelligence monitoring module 40 is additionally connected to and thus provided with the image capture unit 41, the detection unit 42, the infrared light unit 43, the transmission unit 44, the display unit 45, and the ultrasonic rat repellent unit 46, this being in combination with the sticky board 20 which has grid lines 201 on its surface, together with the functions of date, time, temperature, humidity, image capturing, scanning, transmission, and video/audio playing provided in the artificial intelligence monitoring module 40 to achieve improved overall expandability and effective and accurate handling and analysis of environmental conditions and data analysis at a remote site to provide data of instantaneous insect control operations. The housing 10 is additionally provided with the fan 50 to provide an effect of heat dissipation thereby extending service life thereof. The housing 10 is provided with the photo catalyst 60, which after being irradiated with the at least one LED light bar 30, provides effects of deodorization and sterilization. The LED light bar 30 is operated with a direct-current power supply and the LED light bar 30 has advantages of being operated with a small current and a low voltage so as to provide an effect of power saving. The power supply unit 70 is one of a direct-current power supply device, an alternate-current power supply device, a battery, a solar cell, or a combination thereof, to supply electrical power, having an effect of energy saving and environmental protection.

The present invention has a structure the entirety of which is compact and light, having a novel outside appearance, high reliability, and easy maintenance, and such a compact and light overall structure makes it possible for easy installation both indoors and outdoors, or even playing a role of being a decoration to improve flexibility of use thereof. The circuit board of the artificial intelligence monitoring module 40 is arranged on the back side of the partition board 12 to prevent damage caused by long term irradiation of the at least one LED light bar 30. The present invention achieves insect trapping, prevents direct irradiation of light onto human bodies to cause damage of human bodies, provides effect of improved expandability, insect control and prevention, extended lifespan, deodorization and sterilization, energy saving, environmental friendliness, has a compact and light overall structure, is easy to install, and has improved flexibility of use, so as to enhance practical utilization, convenience, and safety.

What is claimed is:

1. An insect trap device, the insect trap device comprising:
a housing, the housing being formed with a plurality of holes;
a sticky board, the sticky board being arranged on a bottom of the housing, the sticky board having a surface coated with insect sticking glue; and
at least one LED light bar, the at least one LED light bar being arranged in an interior of the housing to provide indirect lighting and emit a wavelength of insect luring light;
wherein the at least one LED light bar emits light that attracts insects to enter through the plurality of holes formed in the housing to get stuck to the sticky board.

2. The insect trap device according to claim 1, wherein the housing is integrally formed as a one-piece structure.

3. The insect trap device according to claim 1, wherein the housing comprises a bottom base, a partition board, and a top cover, the bottom base having two sides each formed with a bent side board, each of the bent side boards having a lower portion formed with an insertion opening to receive the sticky board to insert into and combine with the bottom base and to allow insects to enter, each of the bent side boards being combined with a LED light bar, the bottom base being provided with a back board on a back thereof, the partition board being disposed on the bottom base that is arranged adjacent to the back board, the top cover having opposite sides respectively formed with folded sections combinable with the bent side boards of the bottom base, the housing being formed with an opening in a front side thereof, the top cover being formed with the plurality of holes for entry of insects.

4. The insect trap device according to claim 1, wherein the surface of the sticky board has grid lines for monitoring and analysis.

5. The insect trap device according to claim 1, wherein the at least one LED light bar provides a light source having a wavelength within the range of long ultraviolet light, of which the wavelength ranges between 350-380 nm, of which a primary wavelength range is 355-370 nm, for enhancing the performance of insect trapping,

6. The insect trap device according to claim 1, wherein the housing is provided therein with an artificial intelligence monitoring module for instantaneous monitoring and analysis.

7. The insect trap device according to claim 6, wherein the artificial intelligence monitoring module is connected to and configured with an image capture unit, a detection unit, an infrared light unit, a transmission unit, a display unit, and an ultrasonic rat repellent unit.

8. The insect trap device according to claim 7, wherein the image capture unit that is connected to and configured with the artificial intelligence monitoring module is operable to monitor number and species of insects that are trapped, and the transmission unit transmits and controls temperature and humidity.

9. The insect trap device according to claim 1, wherein the housing comprises a fan for dissipation of heat.

10. The insect trap device according to claim 1, wherein the housing is provided therein with a photo catalyst, which irradiated with the at least one LED light bar to achieve deodorization and sterilization.

11. The insect trap device according to claim 10, wherein the photo catalyst comprises titanium dioxide.

12. The insect trap device according to claim 1, wherein the housing is provided with a power supply unit to supply electrical power.

13. The insect trap device according to claim 12, wherein the power supply unit comprises one of a direct-current power supply device, an alternate-current power supply device, a battery, a solar cell, or a combination thereof.

14. The insect trap device according to claim 3, wherein the bottom base of the housing is formed with a pair of wall-mounting apertures for mounting to a wall.

15. The insect trap device according to claim 3, wherein the housing is provided therein with an artificial intelligence monitoring module, the artificial intelligence monitoring module having a circuit board that is disposed on a back side of the partition board, the artificial intelligence monitoring module being connected to and configured with an image capture unit, a detection unit, an infrared light unit, a transmission unit, a display unit, and an ultrasonic rat repellent unit.

16. The insect trap device according to claim 15, wherein the image capture unit that is connected to and configured with the artificial intelligence monitoring module is operable to monitor number and species of insects that are trapped, and the transmission unit transmits and controls temperature and humidity.
